(19) United States
(12) Patent Application Publication
(10) Pub. No.: US 2026/0278414 A1
(43) Pub. Date: Sep. 17, 2026

(54) INFORMATION PROCESSING APPARATUS, INFORMATION PROCESSING METHOD, AND STORAGE MEDIUM

(71) Applicant: NEC Corporation, Tokyo (JP)

(72) Inventor: Kazeto YAMAMOTO, Tokyo (JP)

(73) Assignee: NEC Corporation, Tokyo (JP)

(21) Appl. No.: 19/167,426

(22) PCT Filed: Mar. 28, 2023
(86) PCT No.: PCT/JP2023/012632

§ 371 Date: Sep. 22, 2025

(51) Int. Cl. G06N 5/04

(52) U.S. Cl. CPC G06N 5/04

(57) ABSTRACT

An information processing apparatus of the present disclosure includes: a generating unit configured to generate a candidate hypothesis based on an observation logical formula and background knowledge; a deciding unit configured to calculate an upper bound on the number of logical constraints that should be satisfied by the candidate hypothesis based on the observation logical formula and the background knowledge, and perform decision making on a method for processing the logical constraints when performing abductive reasoning in accordance with the calculated upper bound; and an inference unit configured to process the logical constraints by the decided processing method, and perform abductive reasoning on the candidate hypothesis.

### TECHNICAL FIELD

The present disclosure relates to an information processing apparatus, an information processing method, and a storage medium.

### BACKGROUND ART

Abductive reasoning (abduction) is a reasoning method of receiving an observation logical formula and background knowledge and, based on a function (evaluation function) expressing the goodness of each candidate by a real value, outputting the best logical formula (best hypothesis, solution hypothesis) among logical formulas that are consistent with the background knowledge and that deductively derive the observation logical formula.

As an existing method for implementing abductive reasoning on a computer, a method described in Non-Patent Literature 1 can be cited, where candidates of the best hypothesis (candidate hypotheses) are enumerated based on an observation logical formula and background knowledge, a problem of searching for the best hypothesis therefrom is equivalently converted into a constrained combinatorial optimization problem such as an integer linear programming problem, and the best hypothesis is obtained using an external solver. In this existing method, constraints (logical constraints) that the respective candidate hypotheses should satisfy in order to meet the consistency with the background knowledge are enumerated at the same time when the candidate hypotheses are enumerated and, at the time of searching for the optimal solution using the external solver, are expressed as constraints in the constrained combinatorial optimization problem, so that the obtained optimal solution is guaranteed consistent.

As another existing method for handling logical constraints in abductive reasoning, a method as shown in Non-Patent Literature 2 can be cited, where logical constraints are not enumerated at the time of enumerating candidate hypotheses, but a tentative solution is obtained using an external solver and then it is determined whether the solution is inconsistent with the logical constraints. In this existing method, for a logical constraint related to a transition law holding in an equivalence relation among logical constraints, logical constraints are not enumerated at the time of enumerating candidate hypotheses, but after a tentative solution is obtained using an external solver, the consistency with the logical constraint related to the transition law is determined with respect to an equivalence relation holding in the solution, and the solution is output as the optimal solution when the consistency is confirmed. On the other hand, when it is inconsistent with any logical constraint, the logical constraint is added as a constraint in a constrained combinatorial problem being solved by the external solver, and a tentative solution is obtained again by the external solver. By repeating such a procedure until the optimal solution is obtained, a consistent solution hypothesis can be obtained without explicitly enumerating a specific kind of logical constraints. Such a reasoning method is referred to as cutting plane inference.

### CITATION LIST

### Non-Patent Literature

Non-Patent Literature 1: Naoya Inoue and Kentaro Inui, “ILP-based Reasoning for Weighted Abduction”, Proceedings of AAAI Workshop on Plan, Activity and Intent Recognition, August 2011, pp. 25-32
Non-Patent Literature 2: Naoya Inoue and Kentaro Inui, “Large-scale cost-based abduction in full-fledged first-order predicate logic with cutting plane inference”, Proceedings of the 13th European conference on Logics in Artificial Intelligence, September 2012, pp. 281-293

### SUMMARY OF INVENTION

### Technical Problem

Here, the target for cutting plane inference in the abovementioned method is only a predetermined specific type of logical constraints. Therefore, in a case where a large number of logical constraints of kinds other than the target for cutting plane inference are enumerated, there is a problem that the computation speed significantly lowers. On the other hand, it may be possible to make all the logical constraints to be the target for cutting plane inference, but in that case, it is required to execute an external solver and obtain a tentative solution many times until a consistent solution is obtained, which is also inefficient.

Accordingly, an object of the present disclosure is to provide an information processing apparatus that can solve the abovementioned problem that computation efficiency lowers in abductive reasoning.

### Solution to Problem

An information processing apparatus as an aspect of the present disclosure includes: a generating unit configured to generate a candidate hypothesis based on an observation logical formula and background knowledge; a deciding unit configured to calculate an upper bound on the number of logical constraints that should be satisfied by the candidate hypothesis based on the observation logical formula and the background knowledge, and select a method for processing the logical constraints when performing abductive reasoning in accordance with the calculated upper bound; and an inference unit configured to process the logical constraints by the decided processing method, and perform abductive reasoning on the candidate hypothesis.

Further, an information processing method as an aspect of the present disclosure includes: generating a candidate hypothesis based on an observation logical formula and background knowledge; calculating an upper bound on the number of logical constraints that should be satisfied by the candidate hypothesis based on the observation logical formula and the background knowledge, and selecting a method for processing the logical constraints when performing abductive reasoning in accordance with the calculated upper bound; and processing the logical constraints by the decided processing method, and performing abductive reasoning on the candidate hypothesis.

Further, a program as an aspect of the present disclosure includes instructions for causing a computer to execute processes to: generate a candidate hypothesis based on an observation logical formula and background knowledge; calculate an upper bound on the number of logical constraints that should be satisfied by the candidate hypothesis based on the observation logical formula and the background knowledge, and select a method for processing the logical constraints when performing abductive reasoning in accordance with the calculated upper bound; and process the logical constraints by the decided processing method, and perform abductive reasoning on the candidate hypothesis.

### Advantageous Effects of Invention

Configured as described above, the present disclosure can achieve increase of computation efficiency in abductive reasoning.

### BRIEF DESCRIPTION OF THE DRAWINGS

FIG. 1 is a block diagram showing a configuration of an information processing apparatus disclosed in FIG. 1.

FIG. 2 is a diagram showing a state of processing by the information processing apparatus disclosed in FIG. 1.

FIG. 3 is a diagram showing a state of processing by the information processing apparatus disclosed in FIG. 1.

FIG. 4 is a diagram showing a state of processing by the information processing apparatus disclosed in FIG. 1.

FIG. 5 is a block diagram showing a hardware configuration of an information processing apparatus in a second example embodiment of the present disclosure.

FIG. 6 is a block diagram showing a configuration of the information processing apparatus in the second example embodiment of the present disclosure.

### DESCRIPTION OF EXAMPLE EMBODIMENTS

### FIRST EXAMPLE EMBODIMENT

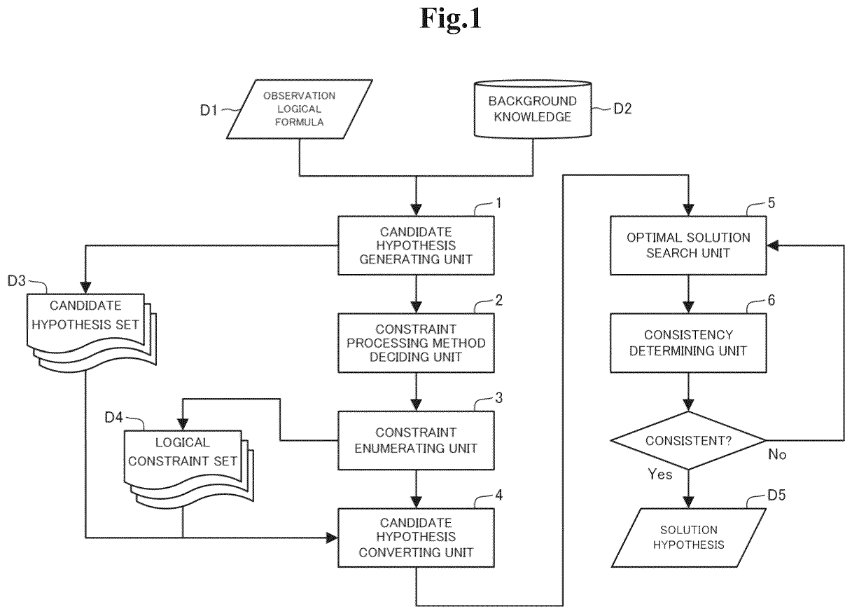

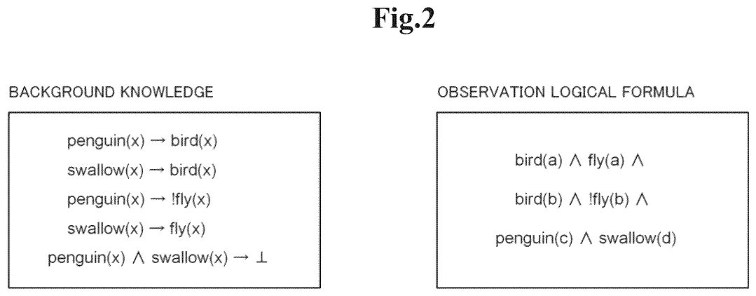

A first example embodiment of the present disclosure will be described with reference to FIGS. 1 to 4. FIG. 1 is a diagram for describing a configuration of an information processing apparatus, and FIGS. 2 to 4 are diagrams for describing processing operation of the information processing apparatus.

### Configuration

The information processing apparatus in this example embodiment has a function of performing abductive reasoning for deriving the best solution consistent with background knowledge from candidate hypotheses by an observation logical formula. Consequently, the information processing apparatus in this example embodiment can be applied to, for example, uses such as explanation generation and situation understanding using background knowledge and observation information. More specifically, the information processing apparatus can be applied to a medical system and an automatic system that performs legal consultation, risk detection or the like.

FIG. 1 is a diagram showing the configuration and processing flow of the information processing apparatus in this example embodiment. The information processing apparatus is configured with one or a plurality of information processing apparatuses each including an arithmetic logic unit and a memory unit. Then, as shown in FIG. 1, the information processing apparatus includes a candidate hypothesis generating unit 1, a constraint processing method deciding unit 2, a constraint enumerating unit 3, a candidate hypothesis converting unit 4, an optimal solution search unit 5, and a consistency determining unit 6. The respective functions of the candidate hypothesis generating unit 1, the constraint processing method deciding unit 2, the constraint enumerating unit 3, the candidate hypothesis converting unit 4, the optimal solution search unit 5, and the consistency determining unit 6 can be enabled by execution of a program for enabling the respective functions stored in the memory unit by the arithmetic logic unit. Further, the information processing apparatus is configured by storing an observation logical formula D1, background knowledge D2, a candidate hypothesis set D3, a logical constraint set D4, and a solution hypothesis D5 into the memory unit. The respective components will be described in detail below.

The candidate hypothesis generating unit 1 (generating unit) receives the observation logical formula D1 and the background knowledge D2 as input, and outputs the candidate hypothesis set D3. The observation logical formula D1 is a conjunction of first-order predicate logic literals that represents observation information. A first-order predicate logic literal is an atomic logical formula in the first-order predicate logic or its negation. The background knowledge D2 is a set of inference rules. An inference rule is generally represented by a horn clause in the first-order predicate logic. To be more specific, an operation of generating, with a candidate hypothesis composed of only an observation logical formula as an initial element, a new candidate hypothesis by applying an inference rule to the candidate hypothesis is repeated until no more new operation can be performed. As the operation used at this time, basically the one in an existing method is employed, but any other method can be used. The candidate hypothesis set D3 is a set of candidate hypotheses output by the candidate hypothesis generating unit 1. The candidate hypotheses are each expressed as a conjunction of first-order predicate logic literals.

The constraint processing method deciding unit 2 (deciding unit) decides a processing method on a logical constraint that should be satisfied in each of the candidate hypotheses included in the candidate hypothesis set D3. Here, the logical constraint processing method includes a first processing method of pre-enumerating logical constraints together with candidate hypotheses as described in Non-Patent Literature 1 mentioned above, and a second processing method of post-determining consistency with logical constraints of the candidate hypothesis as described in Patent Literature 2. Then, the constraint processing method deciding unit 2 calculates the upper bound of the number of logical constraints that should be satisfied by the candidate hypothesis based on the observation logical formula and the background knowledge and, in accordance with the calculated upper bound, decides whether the logical constraint at the time of abductive reasoning is to be processed by either of the processing methods described above. At this time, the constraint processing method deciding unit 2 decides to use the first processing method when the upper bound of the number of logical constraints calculated for the logical constraint is less than a set threshold value, and decides to use the second processing method when the upper bound of the number of logical constraints calculated for the logical constraint is equal to or more than the set threshold value. That is to say, in the case of determining that the number of logical constraints is less than a preset criterion, the constraint processing method deciding unit 2 decides to employ the first processing method of pre-enumerating the logical constraints, and in the case of determining that the number of logical constraints is more than the preset criterion, the constraint processing method deciding unit 2 decides to employ the second processing method of post-determining without pre-enumerating the logical constraints.

Here, the constraint processing method deciding unit 2 calculates the upper bound of the number of logical constraints, for example, in the following manner. First, the constraint processing method deciding unit 2 focuses on each of the first-order predicate logical literals included in the observation logical formula and calculates the upper bound of the number of sets of gathered logical constraints related to the first-order predicate logical literal being focused on. At this time, the constraint processing method deciding unit 2 calculates the upper bound based on background knowledge including the first-order predicate logical literal being focused on and the first-order predicate logical literal in the observation logical formula. For example, the constraint processing method deciding unit 2 specifies background knowledge including the first-order predicate logical literal being focused on, and calculates the upper bound based on the number of combinations of first-order predicate logical literals in the observation logical formula corresponding to the first-order predicate logical literal included in the specified background knowledge. The details of the method for calculating the upper bound of the number of logical constraints by the constraint processing method deciding unit 2 will be described later.

The constraint enumerating unit 3 (inference unit) enumerates logical constraints that each of the candidate hypotheses included in the candidate hypothesis set D3 should satisfy. That is to say, in a case where the constraint processing method deciding unit 2 described above decides to process the logical constraints by the first processing method, the constraint enumerating unit 3 enumerates the logical constraints. Then, the constraint enumerating unit 3 stores the enumerated logical constraints into the logical constraint set D4. The logical constraint set D4 is a set of logical constraints that should be satisfied by each of the candidate hypotheses. In general, each logical constraint is expressed as a conjunction of combinations of first-order predicate logic literals that should not be satisfied among first-order predicate logic literals constituting a candidate hypothesis.

The candidate hypothesis converting unit 4 (inference unit) receives the candidate hypothesis set D3 and the constraint set D4 as input, and outputs a constrained combinatorial optimization problem that is equivalent to a procedure for selecting the best candidate hypothesis that meets all constraints from the candidate hypothesis set. Regarding the conversion procedure at this time, the one in the existing method as described above is used basically, but any other method can also be used.

The optimal solution search unit 5 (inference unit) receives the constrained combinatorial optimization problem generated by the candidate hypothesis converting unit 4 as input, and searches for the optimal solution to the problem using an external solver. Although this solution is the optimal solution to the constrained combinatorial optimization problem, it is not a solution obtained in consideration of all the logical constraints, and therefore, a candidate hypothesis selected based on this solution is handled as a tentative solution hypothesis in abductive reasoning.

The consistency determining unit 6 (inference unit) determines whether the tentative solution obtained by the optimal solution search unit 5 satisfies the logical constraints decided to be the second processing method described above by the constraint processing method deciding unit 2, that is, the logical constraints having been the target for cutting plane interference. In a case where the tentative solution satisfies all the logical constraints, this solution is output as the solution hypothesis D5. On the other hand, in a case where there is a logical constraint that is not satisfied, the logical constraint is added to the logical constraint set D4, and the processing is looped to the optimization solution search unit 5 again. This loop is repeated until a solution satisfying all the logical constraints is obtained or all the logical constraints are added to the logical constraint set D4 finally. The best hypothesis D5 is the one among the candidate hypotheses included in the candidate hypothesis set D3 that satisfies all the logical constraints that should be met and is optimal under the evaluation function.

### Operation

Next, the operation of the abovementioned information processing apparatus will be described with reference to FIG. 1.

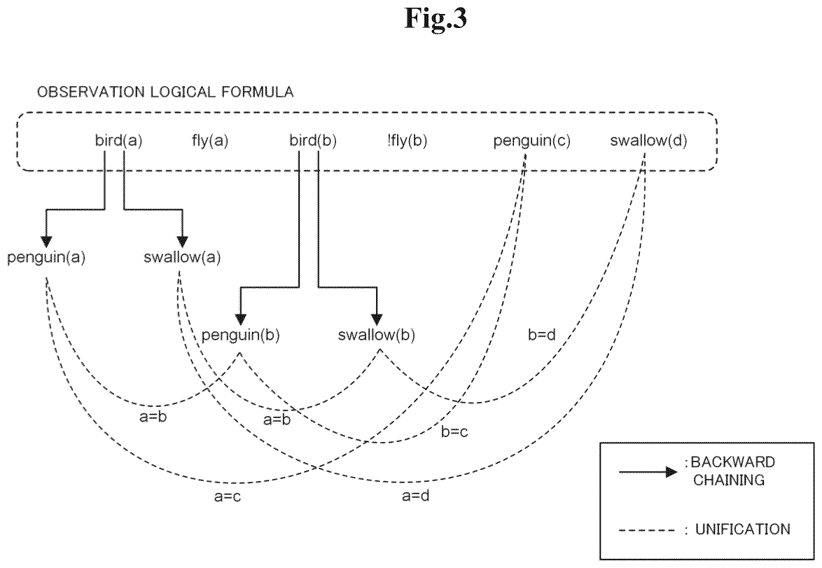

First, for example, according to the method based on Non-Patent Literature 1, the candidate hypothesis generating unit 1 generates a new candidate hypothesis by selecting and applying one applicable operation with candidate hypotheses composed of only observation logical formulas as an initial state. There are two operations that can be performed here: backward chaining and unification. The backward chaining, which is an operation of applying a rule included in background knowledge in a backward manner to an existing candidate hypothesis, is to generate as a new candidate hypothesis a hypothesis such that the consequent (right side, consequence) of the rule is made to correspond to a literal in the candidate hypothesis and a literal corresponding to the antecedent (left side, premise) is added thereto. The unification is to, targeting a pair of literals with the same predicate in an existing candidate hypothesis, generate as a new candidate hypothesis a candidate hypothesis such that the equivalence relation between arguments making the literals identical is added. The candidate hypothesis generated by the candidate hypothesis generating unit 1 is stored into the candidate hypothesis set D3. An example of generating a candidate hypothesis will be described with reference to FIGS. 2 and 3 later in the description of a specific example.

Subsequently, the constraint processing method deciding unit 2 decides a processing method for a logical constraint that should be satisfied in each candidate hypothesis included in the candidate hypothesis set D3. More specifically, this process is to decide whether the logical constraints are to be enumerated by the constraint enumerating unit 3, or, without enumerating the logical constraints, to be determined by the consistency determining unit 6 as a target for cutting plane inference. As the determination criterion at this time, any method may be used, but basically, the upper bound of the number of logical constraints when enumerated is evaluated, and it is decided based on whether the value exceeds some threshold value. An example of evaluation of the upper bound of logical constraints will be described with reference to FIGS. 2 and 3 later in the description of a specific example.

Subsequently, the constraint enumerating unit 3 enumerates logical constraints that should be satisfied for the respective candidate hypotheses. Basically, in the same manner as the existing method described above, this process is enabled by, with respect to literals included in candidate hypotheses and rules included in background knowledge, searching for a combination of a literal inconsistent with a rule. The enumerated logical constraints are stored into the logical constraint set D4.

Subsequently, the candidate hypothesis converting unit 4 outputs a corresponding constrained combinatorial optimization problem from the candidate hypothesis set D3 and the logical constraint set D4. For example, according to the method based on Non-Patent Literature 1, the constrained combinatorial optimization problem to be output is expressed as an integer linear programming problem, but it may be expressed as another problem such as a weighted maximum satisfiability problem. A variable in a combinatorial optimization problem corresponds to the presence or absence of a literal in a candidate hypothesis, and a constraint in the combinatorial optimization problem is used to express a logical constraint in the candidate hypothesis, a precondition caused by an evaluation function, and so forth. An objective function in the combinatorial optimization problem is designed to be equivalent to an evaluation function in abductive reasoning.

Subsequently, the optimal solution search unit 5 searches for and outputs a tentative solution hypothesis from the candidate hypothesis set D3. This process is enabled by using an external solver corresponding to the type of a problem output by the candidate hypothesis converting unit 4. According to the method based on Non-Patent Literature 1, an optimal solution is obtained using a solver for an integer linear programming problem, and a candidate hypothesis corresponding to the optimal solution is used as a tentative solution hypothesis.

Subsequently, the consistency determining unit 6 determines whether the tentative solution obtained by the optimal solution search unit 5 satisfies a logical constraint having been the target of cutting plane interference by the constraint processing method deciding unit 2. In a case where the tentative solution satisfies all the logical constraints, this solution is output as the best hypothesis D5. On the other hand, in a case where there is a logical constraint that is not satisfied, the logical constraint is added to the logical constraint set D4 and then the processing is looped to the optimal solution search unit 5 again. This loop is repeated until a solution satisfying all the logical constraints is obtained or all the logical constraints are added to the logical constraint set D4 finally.

### Specific Example

Next, the abovementioned operation of the information processing apparatus will be described with a specific example. Here, a case of performing abductive reasoning on an observation logical formula and background knowledge as shown in FIG. 2 will be considered.

First, the candidate hypothesis generating unit 1 generates a candidate hypothesis set from the observation logical formula and the background knowledge. More specifically, with a candidate hypothesis composed of only an observation logical formula as an initial state, the backward chaining operation and the unification operation are applied as shown in FIG. 3, and thereby a candidate hypotheses set is constructed. Thus, the candidate hypotheses as shown in FIG. 3 are generated.

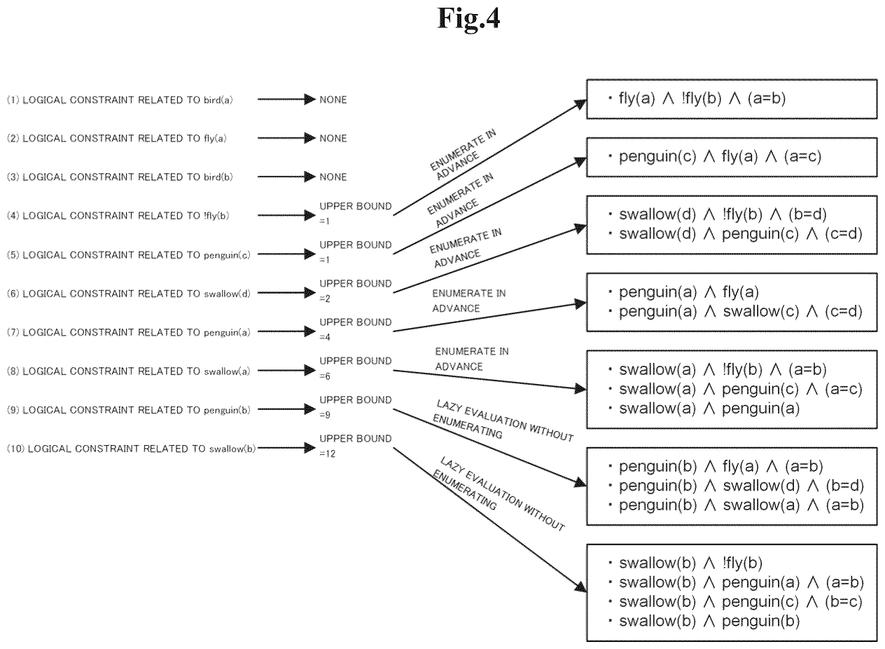

Next, the constraint processing method deciding unit 2 decides a processing method for logical constraints that should be satisfied by individual candidate hypotheses. At this time, the processing method is decided for each gathering of logical constraints defined according to any criterion. For example, in the case of sorting literals included in the candidate hypotheses in order of appearance and then enumerating as one gathering “logical constraints including a specific literal and composed of only literals having appeared prior to the literal, logical constraints on the candidate hypotheses shown in FIG. 3 are processed in gatherings as shown in FIG. 4. At this time, the constraint processing method deciding unit 2 estimates the upper bound of the enumeration number for each gathering, and decides how to handle the gathering of the logical constraints in accordance with the value.

Here, for example, let us consider a case where a gathering with the upper bound of equal to or more than 8 is handled as the target of cutting plane interference and a processing method on logical constraints related to literal penguin(b) is decided. At this time, in the background knowledge shown in FIG. 2, there are two inference rules including predicate penguin: penguin(x)→!fly(x) and penguin(x)∧swallow(x)→⊥. Therefore, the upper bound of the enumeration number of logical constraints here is the sum of the upper bounds of combinations of literals that are inconsistent with these inference rules. For example, the upper bound of combinations of literals inconsistent with penguin(x)→!fly(x) can be calculated as the number of combinations of literals having predicate penguin and predicate fly in the literal to be considered, so that, here, 1×3=3. Likewise, the upper bound of combinations of literals inconsistent with penguin(x)∧swallow(x)→⊥ is 2×3=6 because there are three literals having predicate penguin and two literals having predicate swallow. Therefore, the upper bound of the number of logical constraints related to literal penguin(b) is 9, which exceeds the threshold value 8 defined above, so that these logical constraints are not enumerated and are subject to cutting plane interference.

Next, the constraint enumerating unit 3 enumerates specific combinations of literals with respect to the gathering of logical constraints having been the target of pre-enumeration by the constraint processing method deciding unit. The logical constraints for the candidate hypotheses shown in FIG. 3 are enumerated as shown in FIG. 4.

The candidate hypothesis converting unit 4 expresses and outputs as a constrained combinatorial optimization problem a procedure for searching for the best hypothesis from among candidate hypotheses that are included in the candidate hypothesis set D3 and that do not meet a combination included in the logical constraint set D4. According to the method of Non-Patent Literature 1, the procedure for searching for the best hypothesis is expressed as an equivalent integer linear programming problem.

The optimal solution search unit 5 receives the constrained combinatorial optimization problem as input from the candidate hypothesis converting unit, and searches for and outputs the best hypothesis. According to the method of Non-Patent Literature 1, the best hypothesis is searched for by receiving an integer linear programming problem as input and solving it using an external integer linear programming problem solver.

The consistency determining unit 6 determines whether the best hypothesis obtained by the optimal solution search unit 5 is consistent with the logical constraint having been the target of cutting plane interference by the constraint processing method deciding unit, and when consistent, outputs the hypothesis as the solution hypothesis D5. On the other hand, in a case where an inconsistent logical constraint is found, the logical constraint is added to the logical constraint set D4, and processing is looped to the optimal solution search unit 5. For example, let us consider a case where the best hypothesis for the input shown in FIG. 2 is obtained as a hypothesis bird(a)∧fly(a)∧bird(b)∧!fly(b)∧penguin(c)∧swallow(d)∧swallow(a)∧(a=d)∧swallow(b)∧(b=d). The consistency determining unit 6 determines whether the hypothesis is consistent with logical constraint gatherings (9) and (10) shown in FIG. 4. First, it is obvious that the hypothesis is consistent with the logical constraint (9) related to literal penguin(b) because the hypothesis does not include this literal. Next, regarding the logical constraint (10) related to literal swallow(b), the consistency verification is performed by determining whether there exists any combination that is inconsistent with the inference rules between this literal and other literals included in the best hypothesis. In this case, the combination of swallow(b)∧!fly(b) is inconsistent with the inference rule, so that this combination is added to the logical constraint set D4 as a logical constraint, and the processing is looped to the optimal solution search unit 5 again.

### Effect

As described above, according to the information processing apparatus described above, as a first effect, it is possible to appropriately select a processing method for each logical constraint in accordance with the situation. This is because it is possible to determine whether cutting plane interference should be applied by evaluating the upper bound of the number to be enumerated before enumerating individual logical constraints. Empirically, since the benefit of cutting plane interference is larger as the number of enumerated logical constraints is larger, by selecting objects based on the upper bound of the number to be enumerated as a determination criterion, it is possible to target only logical constraints such that the benefit of cutting plane interference can be strongly obtained.

A second effect is that an inference process in abductive reasoning can be performed more efficiently than in a conventional reasoning method in respect to both memory and computation time. This is because, due to the first effect described above, logical constraints that are enumerated in large numbers are subject to Cutting Plane Inference, making it possible to avoid the process of explicitly enumerating those logical constraints, which would otherwise require a large amount of memory and computational time.

A third effect is that the entire procedure of abductive reasoning can be performed more efficiently than in a conventional method in terms of both memory and computation time. This is because, in addition to reducing memory and computation time for enumerating logical constraints due to the abovementioned second effect, it is possible to, due to the second effect, reduce the number of constraints in a constrained combinatorial optimization problem given to a solver, thereby reducing memory and computation time in a procedure of searching for the optimal solution by an external solver.

### SECOND EXAMPLE EMBODIMENT

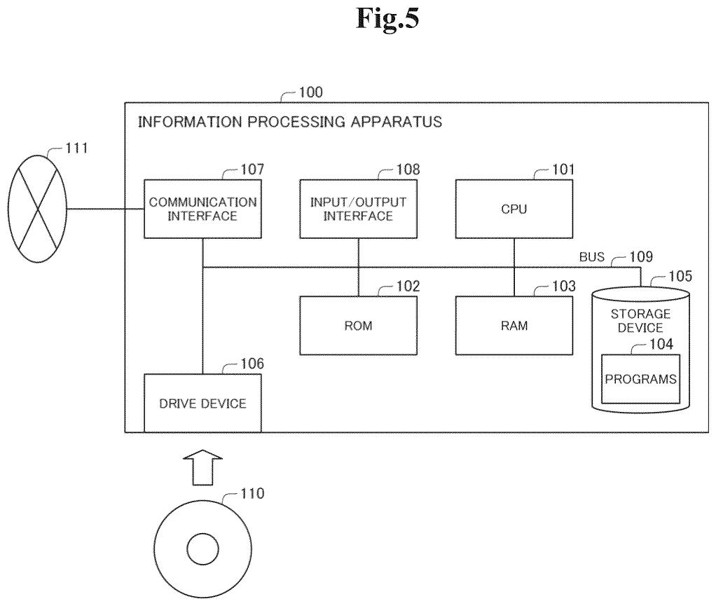

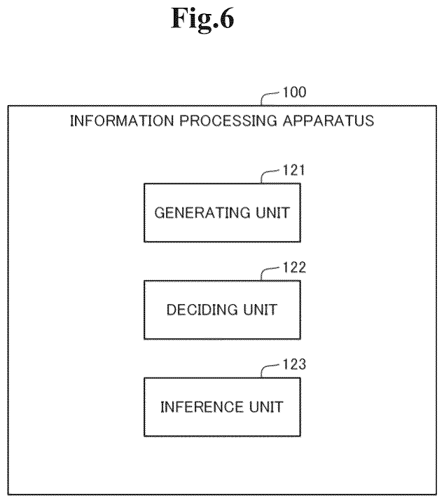

Next, a second example embodiment of the present disclosure will be described with reference to FIGS. 5 to 6. FIGS. 5 to 6 are block diagrams showing a configuration of an information processing apparatus in the second example embodiment. This example embodiment shows the overview of the configuration of the information processing apparatus described in the above example embodiment.

First, a hardware configuration of an information processing apparatus 100 in this example embodiment will be described with reference to FIG. 5. The information processing apparatus 100 is configured with a general information processing apparatus and, as an example, has the following hardware configuration including:
a CPU (Central Processing Unit) 101 (arithmetic logic unit);
a ROM (Read Only Memory) 102 (memory unit);
a RAM (Random Access Memory) 103 (memory unit);
programs 104 loaded into the RAM 103;
a storage device 105 storing the programs 104;
a drive device 106 that performs reading from and writing into a storage medium 110 external to the information processing apparatus;
a communication interface 107 connected to a communication network 111 external to the information processing apparatus;
an input/output interface 108 that performs input/output of data; and
a bus 109 connecting the components.

FIG. 5 shows an example of the hardware configuration of the information processing apparatus serving as the information processing apparatus 100, and the hardware configuration of the information processing apparatus is not limited to the abovementioned case. For example, the information processing apparatus may be configured with part of the abovementioned configuration, such as not having the drive device 106. Moreover, the information processing apparatus may use a GPU (Graphic Processing Unit), a DSP (Digital Signal Processor), an MPU (Micro Processing Unit), an FPU (Floating point number Processing Unit), a PPU (Physics Processing Unit), a TPU (Tensor Processing Unit), a quantum processor, a microcontroller, or a combination of these, instead of the abovementioned CPU.

Then, the information processing apparatus 100 can construct and include a generating unit 121, a deciding unit 122, and an inference unit 123 shown in FIG. 6 by acquisition and execution of the programs 104 by the CPU 101. The programs 104 are, for example, stored in advance in the storage device 105 or the ROM 102, and are loaded into the RAM 103 and executed by the CPU 101 as necessary. In addition, the programs 104 may be provided to the CPU 101 via the communication network 111, or the programs may be stored in advance in the storage medium 110 and read out by the drive device 106 and provided to the CPU 101. However, the generating unit 121, the deciding unit 122, and the inference unit 123 described above may be constructed using dedicated electronic circuits for implementing such means.

The generating unit 121 generates a candidate hypothesis based on an observation logical formula and background knowledge.

The deciding unit 122 calculates the upper bound of the number of logical constraints that should be satisfied by the candidate hypothesis based on the observation logical formula and the background knowledge, and decides a method for processing the logical constraints when performing abductive reasoning in accordance with the calculated upper bound. For example, the deciding unit 122 decides to employ either a first processing method of previously enumerating logical constraints or a second processing method of post-determining consistency with the logical constraints of the candidate hypothesis in accordance with the calculated upper bound. At this time, the deciding unit 122 calculates, for each predicate included in the observation logical formula, the upper bound based on the background knowledge including the predicate and the observation logical formula.

The inference unit 123 processes the logical constraints by the decided processing method, and performs abductive reasoning on the candidate hypothesis.

Configured as described above, the present disclosure enables selection of an appropriate processing method for each logical constraint when performing abductive reasoning on a candidate hypothesis in accordance with the situation. As a result, it is possible to achieve increase of the computational efficiency in abductive reasoning.

The abovementioned program can be stored using various types of non-transitory computer-readable mediums and provided to a computer. The non-transitory computer-readable medium includes various types of tangible storage mediums. Examples of non-transitory computer-readable medium include magnetic recording medium (e.g., flexible disk, magnetic tape, hard disk drive), magneto-optical recording medium (e.g., magneto-optical disk), CD-ROM (read only memory), CD-R, CD-R/W, semiconductor memory (e.g., mask ROM, programmable ROM, EPROM (Erasable PROM), flash ROM, RAM (random access memory)). In addition, a program may be provided to a computer by various types of transitory computer-readable medium. Examples of transitory computer-readable medium include electrical signals, optical signals, and electromagnetic waves. The transitory computer-readable medium can provide a program to a computer via a wired communication channel, such as an electric wire and an optical fiber, or a wireless communication channel.

Although the present disclosure has been described above with reference to the above-described example embodiments, the present disclosure is not limited to the embodiments described above. The configuration and details of the present disclosure can be changed in a variety of ways that those skilled in the art can understand within the scope of the present disclosure. In addition, at least one or more of the functions of the generating unit 121, the deciding unit 122, and the inference unit 123 described above may be executed by an information processing apparatus installed and connected anywhere on the network, that is, may be executed by so-called cloud computing.

### SUPPLEMENTARY NOTES

The whole or part of the example embodiments disclosed above can be described as the following supplementary notes. Hereinafter, the overview of the configurations of an information processing apparatus, an information processing method, and a program in the present disclosure will be described. However, the present disclosure is not limited to the following configurations.

### Supplementary Note 1

An information processing apparatus comprising:
a generating unit configured to generate a candidate hypothesis based on an observation logical formula and background knowledge;
a deciding unit configured to calculate an upper bound on the number of logical constraints that should be satisfied by the candidate hypothesis based on the observation logical formula and the background knowledge, and select a method for processing the logical constraints when performing abductive reasoning in accordance with the calculated upper bound; and
an inference unit configured to process the logical constraints by the decided processing method, and perform abductive reasoning on the candidate hypothesis.

### Supplementary Note 2

The information processing apparatus according to supplementary note 1, wherein
the deciding unit is configured to select the processing method in accordance with the calculated upper bound between a first processing method, in which the logical constraints are enumerated in advance, and a second processing method, in which the consistency of the candidate hypothesis with the logical constraint is determined after generation of the candidate hypothesis.

### Supplementary Note 3

The information processing apparatus according to supplementary note 2, wherein
the deciding unit is configured to select the first processing method in a case where the calculated upper bound is less than a preset threshold value, and to select the second processing method in a case where the calculated upper bound is equal to or greater than the threshold value.

### Supplementary Note 4

The information processing apparatus according to any of supplementary notes 1 to 3, wherein:
the deciding unit is configured to calculate an upper bound on the number of the logical constraints for each set of the logical constraints gathered based on a predicate included in the observation logical formula, and select a processing method for each set of the logical constraints in accordance with the calculated upper bound; and
the inference unit is configured to process each set of the logical constraints using the processing method selected for the set, and perform abductive reasoning on the candidate hypothesis.

### Supplementary Note 5

The information processing apparatus according to any of supplementary notes 1 to 4, wherein:
the deciding unit is configured to, for each predicate included in the observation logical formula, calculate an upper bound on the number of the logical constraints associated with the predicate, and select a method for processing the logical constraints in accordance with the calculated upper bound; and
the inference unit is configured to process the logical constraints associated with the predicate using the processing method selected for each predicate, and perform abductive reasoning on the candidate hypothesis.

### Supplementary Note 6

The information processing apparatus according to supplementary note 5, wherein
the deciding unit is configured to, for each predicate included in the observation logical formula, calculate the upper bound based on the background knowledge including the predicate and the observation logical formula.

### Supplementary Note 7

The information processing apparatus according to supplementary note 6, wherein
the deciding unit is configured to, for each predicate included in the observation logical formula, specify the background knowledge that includes the predicate, and calculate the upper bound based on the number of a combinations of the predicate(s) in the observation logical formula that corresponds to the predicate included in the specified background knowledge.

### Supplementary Note 8

An information processing method comprising:
generating a candidate hypothesis based on an observation logical formula and background knowledge;
calculating an upper bound on the number of logical constraints that should be satisfied by the candidate hypothesis based on the observation logical formula and the background knowledge, and selecting a method for processing the logical constraints when performing abductive reasoning in accordance with the calculated upper bound; and
processing the logical constraints by the decided processing method, and performing abductive reasoning on the candidate hypothesis.

### Supplementary Note 9

The information processing method according to supplementary note 8, comprising
selecting the processing method in accordance with the calculated upper bound between a first processing method, in which the logical constraints are enumerated in advance, and a second processing method, in which the consistency of the candidate hypothesis with the logical constraint is determined after generation of the candidate hypothesis.

### Supplementary Note 10

The information processing method according to supplementary note 8 or 9, comprising:
calculating an upper bound on the number of the logical constraints for each set of the logical constraints gathered based on a predicate included in the observation logical formula, and selecting a processing method for each set of the logical constraints in accordance with a number of the calculated upper bound; and
processing each set of the logical constraints using the processing method selected for the set, and performing abductive reasoning on the candidate hypothesis.

### Supplementary Note 11

The information processing method according to any of supplementary notes 8 to 10, comprising:
for each predicate included in the observation logical formula, calculating an upper bound on the number of the logical constraints associated with the predicate, and selecting a method for processing the logical constraints in accordance with the calculated upper bound; and
processing the logical constraints associated with the predicate using the processing method selected for each predicate, and performing abductive reasoning on the candidate hypothesis.

### Supplementary Note 12

A non-transitory computer-readable storage medium storing a program, the program comprising instructions for causing a computer to execute processes to:
generate a candidate hypothesis based on an observation logical formula and background knowledge;
calculate an upper bound on the number of logical constraints that should be satisfied by the candidate hypothesis based on the observation logical formula and the background knowledge, and select a method for processing the logical constraints when performing abductive reasoning in accordance with the calculated upper bound; and
process the logical constraints by the decided processing method, and perform abductive reasoning on the candidate hypothesis.

### REFERENCE SIGNS LIST

1 candidate hypothesis generating unit
2 constraint processing method deciding unit
3 constraint enumerating unit
4 candidate hypothesis converting unit
5 optimal search unit
6 consistency determining unit
D1 observation logical formula
D2 background knowledge
D3 candidate hypothesis set
D4 logical constraint set
D5 solution hypothesis
100 information processing apparatus
101 CPU
102 ROM
103 RAM
104 programs
105 storage device
106 drive device
107 communication interface
108 input/output interface
109 bus
110 storage medium
111 communication network
121 generating unit
122 deciding unit
123 inference unit

What is claimed is:

1. An information processing apparatus comprising:
at least one memory storing processing instructions; and
at least one processor configured to execute the processing instructions, wherein the processor is configured to execute the processing instructions to:
generate a candidate hypothesis based on an observation logical formula and background knowledge;
calculate an upper bound on the number of logical constraints that should be satisfied by the candidate hypothesis based on the observation logical formula and the background knowledge, and select a method for processing the logical constraints when performing abductive reasoning in accordance with the calculated upper bound; and
process the logical constraints by the decided processing method, and perform abductive reasoning on the candidate hypothesis.

2. The information processing apparatus according to claim 1, wherein the processor is configured to execute the processing instructions to
select the processing method in accordance with the calculated upper bound between a first processing method, in which the logical constraints are enumerated in advance, and a second processing method, in which the consistency of the candidate hypothesis with the logical constraint is determined after generation of the candidate hypothesis.

3. The information processing apparatus according to claim 2, wherein the processor is configured to execute the processing instructions to
select the first processing method in a case where a value of the calculated upper bound is less than a preset threshold value, and to select the second processing method in a case where the value of the calculated upper bound is equal to or greater than the threshold value.

4. The information processing apparatus according to claim 1, wherein the processor is configured to execute the processing instructions to:
calculate an upper bound on the number of the logical constraints for each set of the logical constraints gathered based on a predicate included in the observation logical formula, and select a processing method for each set of the logical constraints in accordance with the calculated upper bound; and
process each set of the logical constraints using the processing method selected for the set, and perform abductive reasoning on the candidate hypothesis.

5. The information processing apparatus according to claim 1, wherein the processor is configured to execute the processing instructions to:
for each predicate included in the observation logical formula, calculate an upper bound on the number of the logical constraints associated with the predicate, and select a method for processing the logical constraints in accordance with the calculated upper bound; and
process the logical constraints associated with the predicate using the processing method selected for each predicate, and perform abductive reasoning on the candidate hypothesis.

6. The information processing apparatus according to claim 5, wherein the processor is configured to execute the processing instructions to
for each predicate included in the observation logical formula, calculate the upper bound based on the background knowledge including the predicate and the observation logical formula.

7. The information processing apparatus according to claim 6, wherein the processor is configured to execute the processing instructions to
for each predicate included in the observation logical formula, specify the background knowledge that includes the predicate, and calculate the upper bound based on the number of combinations of the predicate(s) in the observation logical formula that corresponds to the predicate included in the specified background knowledge.

8. An information processing method comprising:
generating a candidate hypothesis based on an observation logical formula and background knowledge;
calculating an upper bound on the number of logical constraints that should be satisfied by the candidate hypothesis based on the observation logical formula and the background knowledge, and selecting a method for processing the logical constraints when performing abductive reasoning in accordance with the calculated upper bound; and
processing the logical constraints by the decided processing method, and performing abductive reasoning on the candidate hypothesis.

9. The information processing method according to claim 8, comprising
selecting the processing method in accordance with the calculated upper bound between a first processing method, in which the logical constraints are enumerated in advance, and a second processing method, in which the consistency of the candidate hypothesis with the logical constraints is determined after generation of the candidate hypothesis.

10. The information processing method according to claim 8, comprising:
calculating an upper bound on the number of the logical constraints for each set of the logical constraints gathered based on a predicate included in the observation logical formula, and selecting a processing method for each set of the logical constraints in accordance with a number of the calculated upper bound; and
processing each set of the logical constraints using the processing method selected for the set, and performing abductive reasoning on the candidate hypothesis.

11. The information processing method according to claim 8, comprising:
for each predicate included in the observation logical formula, calculating an upper bound on the number of the logical constraints associated with the predicate, and selecting a method for processing the logical constraints in accordance with the calculated upper bound; and
processing the logical constraints associated with the predicate using the processing method selected for each predicate, and performing abductive reasoning on the candidate hypothesis.

12. A non-transitory computer-readable storage medium storing a program, the program comprising instructions for causing a computer to execute processes to:
generate a candidate hypothesis based on an observation logical formula and background knowledge;
calculate an upper bound on the number of logical constraints that should be satisfied by the candidate hypothesis based on the observation logical formula and the background knowledge, and select a method for processing the logical constraints when performing abductive reasoning in accordance with the calculated upper bound; and
process the logical constraints by the decided processing method, and perform abductive reasoning on the candidate hypothesis.
